(19) United States
(12) Patent Application Publication
(10) Pub. No.: US 2007/0252000 A1
(43) Pub. Date: Nov. 1, 2007

(54) Prepay receptacle for dry cleaning drop-off

(76) Inventor: Anita LeNorman, Cypress, TX (US)

Correspondence Address: Anita LeNorman, 19614 Narcissus Brook Lane, Cypress, TX, 77433, US

(21) Appl. No.: 11/732,897

(22) Filed: Apr. 6, 2007

Related U.S. Application Data
(60) Provisional application No. 60/795,724, filed on Apr. 28, 2006.

(51) Int. Cl. G06K 5/00; G06F 17/00

(52) U.S. Cl. 235/380; 235/375

(57) ABSTRACT

A prepay receptacle for dry cleaning drop-off. This unit is houses the merchant card swiping device, software, printer, disposable bags and wire basket on rollers. This single unit will allow a customer to prepay and deposit their articles to be dry cleaned, at their convenience. The customer will be able to place their articles in disposable bags for sanitation purposes. This protects them and the personnel from the dry cleaning establishment. The software is point-of-sale and user friendly. The unit is portable, so there is the convenience to place the unit anywhere the dry cleaning establishment desires. The unit is operational by plugging into standard 110V and a DSL line for transmission of data from the software.

### RELATED APPLICATIONS

The present application is a continuation-in-part application of U.S. provisional patent application Ser. No. 60/795,724, filed Apr. 28, 2007, for PREPAY RECEPTACLE FOR DRY CLEANING PICKUP, by Anita LeNorman, included by reference herein and for which benefit of the priority date is hereby claimed.

### FIELD OF THE INVENTION

The present invention relates to prepay dry cleaning equipment and, more particularly, to prepaying, dropping-off and storing of articles to be dry cleaned.

### BACKGROUND OF THE INVENTION

Dry cleaning is a convenience that carries with it time constraints for the consumer. Employees working standard working hours ofent lack the time to compete this chore. Since most dry cleaning facilities are open during standard working hours, most people have to resort to attempting to get their dry cleaning dropped off that are inconvenient to them, which could include early in the morning or during their lunch hour. Locations of dry cleaning establishments then can create a problem. If there is not a location close to them, the time constraint is then re-enforced.

Most dry cleaning estblishements still handwrite their tickets. This creates the liability of human error in the instructions of processing the clothing or the tallying of the billing. Also, many customers are unaware of when their articles have been processed and ready for pickup.

If dry cleaning establishments were to remain open at all times that were easily accessible to customer, their overhead would increase drastically. Overhead would include things like salaries for extra people and increased utility bills. Also, with employees working shift work, there is the increase of safety issues for the employee, therefore increasing the liability for the establishment. With this type of exposure, obtaining insurance coverage for the establishment would be a problem since most companies do not want to write coverage for establishments open 24 hours a day. There is the increased exposure for crime, increasing the possibility for payment of claims. If the establishment would have to locate a surplus lines market insurance company that would place the coverage for them, causing them to pay an additional premium, fees and taxes, which would add up to more than what they would have paid through a standard admitted insurance company.

In respects to U.S. Pat. No. 6,010,239, it is a convenient drop-off, but it is a stationary unit which does not offer portability and the convenience of a basket on wheels for the easy unloading by personnel.

Dry cleaning establishments have made an attempt to open earlier or stay open later, but this has still not been suitable to gaining the customer base due to time constraints. Other drop-off equipment has been developed, for example U.S. Pat. No. 6,010,239.

### SUMMARY OF THE INVENTION

In accordance with the present invention, there is provided a prepay receptacle for dry cleaning drop-off. This unit is houses the merchant card swiping device, software, printer, disposable bags and wire basket on rollers. The customer swipes their credit or debit card and enter their personal information by use of the touch computer screen. The customer would then use the touch screen to enter the data on the articles being dropped off for dry cleaning. This would be such things as types of articles, material type, number of articles and basic information. The software will tally the cost of cleaning and alterations and deduct the amount from the credit or debit card. The money will be deposited into the appropriate accounts for the dry cleaning establishment. The receipt and label will then be printed. The customer will place the articles in the disposable bag, seal the bag and place the self adhesive label on the bag. The customer will then open the flip up door to the unit and deposit the sealed bag into the unit and close the door. The software will then trigger the unit to relock.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of a FIG. 1 is a front perspective view of a prepay receptacle for dry cleaning drop-off;

FIG. 2 is a left detail view of a FIG. 2 is a left detail view for the disposable bag dispensing and additional disposable bag storage;

FIG. 3 is a front open detail view of a FIG. 3 is a front open detail view of the front of the unit opening, displaying the removable wire basket on rollers;

FIG. 4 is a front partial view of a FIG. 4 is a front partial view of the unit door opening for depositing bagged articles;

FIG. 5 is a flow chart view of a FIG. 5 is a flow chart view of the transactions and process by the software to manipulate the system; and

FIG. 6 is a flow chart view of a FIG. 6 is a flow chart view of the continuation of the transactions and process of the software to manipulate the system.

For purposes of clarity and brevity, like elements and components will bear the same designations and numbering throughout the Figures.

### DESCRIPTION OF THE PREFERRED EMBODIMENT

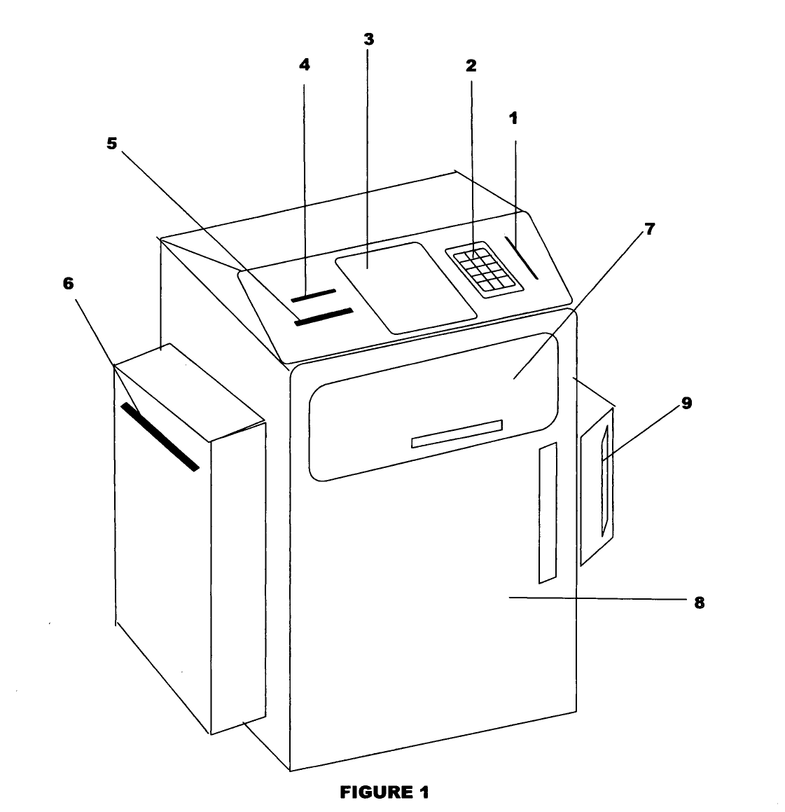

FIG. 1 is a front perspective view of the Prepay Receptacle for Dry Cleaning Drop-Off. The unit, which can be constructed of metal, or some other suitable material, houses the software, computer touch screen 3, master/credit/debit card reader 1, keypad for master/credit/debit card reader 2, receipt printer 4, label printer 5 and dispensed disposable bags 10. Referring to FIG. 1, the computer touch screen 3, master/credit/debit card reader 1, keypad for master/credit/debit card reader 2, receipt printer 4, label printer 5 and dispensed disposable bags 10 can be purchased from various vendors. The point-of-sale software is written specifically for this unit in order for certain actions by the customer to manipulate the system.

Referencing FIG. 1 again, the customer will swipe their credit/debit card in the master/credit/debit card reader 1 and use the keypad for master/credit/debit card reader 2 to enter passcodes. The customer will then enter any personal data, articles information and instructions on the computer touch screen 3. The software will then tally the bill, deduct the funds and then deposit the funds into the appropriate bank accounts. The receipt printer 4 will then dispense a receipt. The label printer 5 will dispense a label will the customer's information and information on the articles to be bagged. A disposable bag will then be dispensed through the disposable bag dispensing slot 6. The software will then unlock the unit door for depositing bagged articles 7. The customer will then place the articles in the diposable bag, remove the strip and seal the bag. The customer will then place the printed label 15 onto the disposable bag. The customer will the open the unit door for depositing bagged articles 7, deposit the sealed bag of articles and close the unit door. The theft guard 12 will keep unauthorized personnel from removing any bagged articles already deposited into the unit. The unit door for depositing bagged articles 7 will relock.

The dry cleaning establishment personnel, when arriving to retrieve deposited bagged articles, will swipe their master card in the master/credit/debit card reader 1. The software will then unlock the unit front door 8. The dry cleaning establishment personnel can then roll out the wire roller basket 13 that is filled with the bagged articles. Once emptying the wire roller basket 13, they would then replace it in the unit and close the unit front door 8. They would then swipe their master card again in the master/credit/debit card reader 1 to relock the unit front door 8.

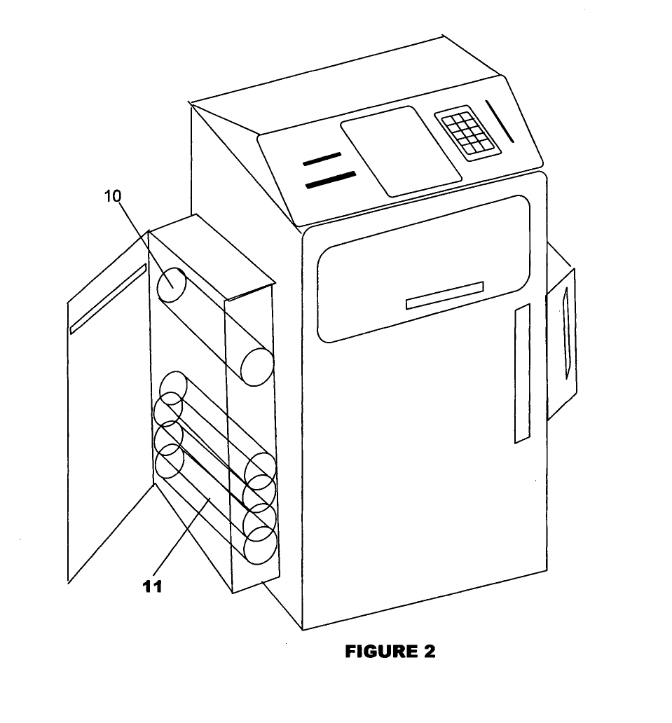

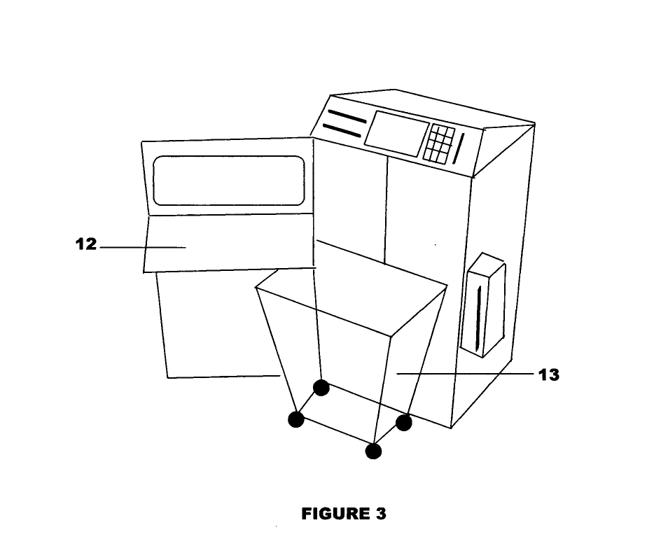

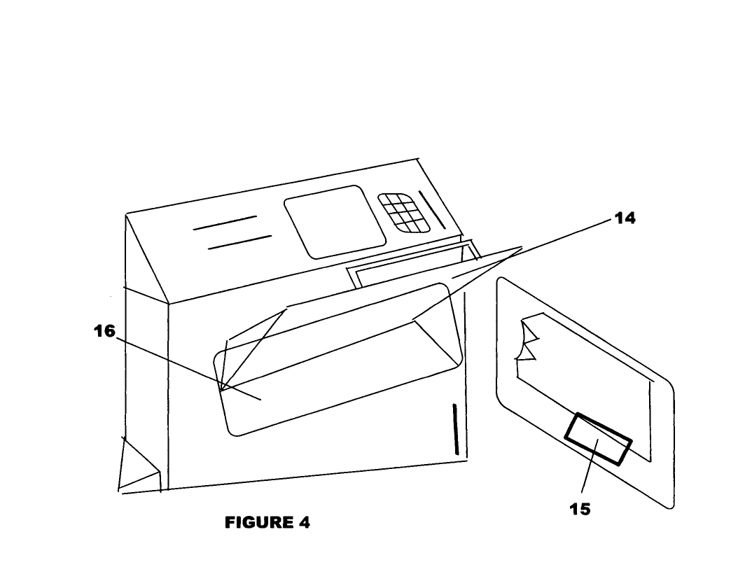

Referencing FIG. 2, this figure reflects the inside of the unit, detail of the disposable bag dispensing unit and storage for extra disposable bags 11. FIG. 3 is the front open detail showing the reflecting how the opened unit door for depositing bagged articles 14 and the wire roller basket 13. FIG. 4 show the comment/instruction box 9, the inside view for theft guard 16 to keep unauthorized persons from removing bagged articles already deposited into the unit.

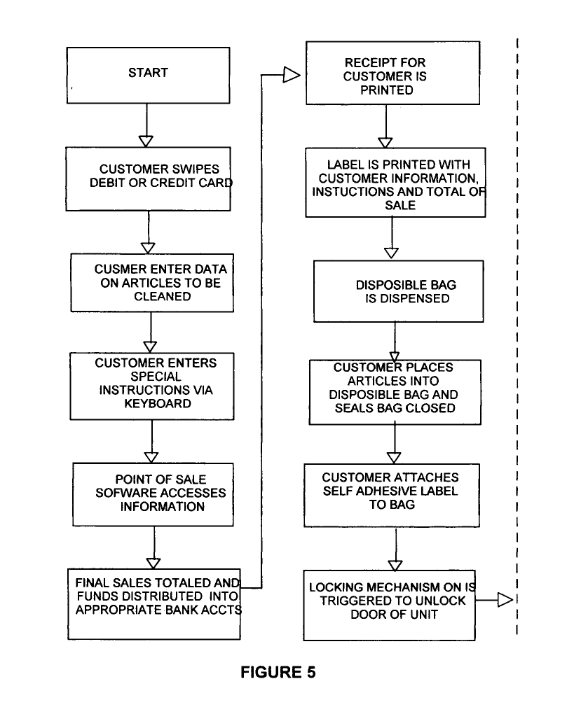

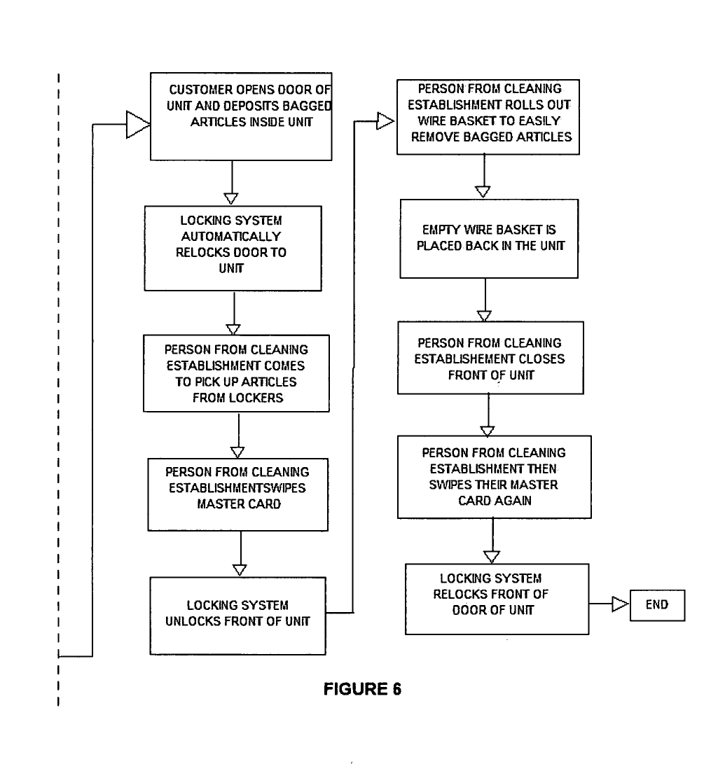

FIGS. 5 and 6 are flow charts of the transactions and process by the software to manipulate the system.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A prepay receptacle for dry cleaning drop-off for a prepay receptacle for dry cleaning drop-off, comprising:
a master/credit/debit card reader, for <purpose>;
a keypad for master/credit/debit card reader, for <purpose>, adjacently connected to said master/credit/debit card reader;
a computer touch screen, for <purpose>, adjacently connected to said keypad for master/credit/debit card reader;
a receipt printer, for <purpose>, automatically connected to said computer touch screen;
a label printer, for <purpose>, automatically connected to said computer touch screen;
a disposable bag dispensing slot, for <purpose>;
an unit door for depositing bagged articles, for <purpose>, automatically connected to said computer touch screen;
a comment/instruction box, for <purpose>;
an unit front door, for <purpose>, automatically connected to said computer touch screen;
a dispensed disposable bags, for <purpose>, automatically connected to said computer touch screen;
a theft guard, for <purpose>;
a wire roller basket, for <purpose>;
an opened unit door for depositing bagged articles, for <purpose>;
a printed label, for <purpose>; and
an inside view for theft guard, for <purpose>.

2. The prepay receptacle for dry cleaning drop-off as recited in claim 1, further comprising:
a storage for extra disposable bags, for <purpose>.

3. A prepay receptacle for dry cleaning drop-off for a prepay receptacle for dry cleaning drop-off, comprising:
a master/credit/debit card reader, for <purpose>;
a keypad for master/credit/debit card reader, for <purpose>, adjacently connected to said master/credit/debit card reader;
a computer touch screen, for <purpose>, adjacently connected to said keypad for master/credit/debit card reader;
a receipt printer, for <purpose>, automatically connected to said computer touch screen;
a label printer, for <purpose>, automatically connected to said computer touch screen;
a disposable bag dispensing slot, for <purpose>;
an unit door for depositing bagged articles, for <purpose>, automatically connected to said computer touch screen;
a comment/instruction box, for <purpose>;
an unit front door, for <purpose>, automatically connected to said computer touch screen;
a dispensed disposable bags, for <purpose>, automatically connected to said computer touch screen;
a storage for extra disposable bags, for <purpose>;
a theft guard, for <purpose>;
a wire roller basket, for <purpose>;
an opened unit door for depositing bagged articles, for <purpose>;
a printed label, for <purpose>; and
an inside view for theft guard, for <purpose>.
